(19) United States
(12) Patent Application Publication
(10) Pub. No.: US 2023/0395977 A1
(43) Pub. Date: Dec. 7, 2023

(54) CIRCULAR POLARIZED ARRAY ANTENNA AND ELECTRONIC APPARATUS

(71) Applicant: KYOCERA Corporation, Kyoto-shi, Kyoto (JP)

(72) Inventors: Takaki NAKAJIMA, Soraku-gun (JP); Takumi HIRAI, Kyotanabe-shi (JP); Daisuke YAMAMOTO, Kizugawa-shi (JP); Tatsuya MORITA, Soraku-gun (JP); Kazuki HAYATA, Soraku-gun (JP)

(73) Assignee: KYOCERA Corporation, Kyoto-shi, Kyoto (JP)

(21) Appl. No.: 18/278,751

(22) PCT Filed: Feb. 18, 2022
(86) PCT No.: PCT/JP2022/006577

§ 371 Date: Aug. 24, 2023

(30) Foreign Application Priority Data
Feb. 26, 2021 (JP) 2021-029653
Sep. 28, 2021 (JP) 2021-157569

(51) Int. Cl. H01Q 9/04; H01Q 1/48; H01Q 21/08

(52) U.S. Cl. CPC H01Q 9/0428; H01Q 1/48; H01Q 21/08

(57) ABSTRACT

A circular polarized array antenna includes an antenna layer and a ground layer. The antenna layer includes a plurality of antenna elements disposed at different positions in plan view. Each of the antenna elements is composed of a circular polarized antenna. The ground layer faces the antenna layer. The ground layer includes a plurality of ground patterns separated from each other. Each of the ground patterns faces one or more of the antenna elements.

### TECHNICAL FIELD

The present disclosure relates to a circular polarized array antenna and an electronic apparatus including the antenna.

### BACKGROUND OF INVENTION

A known array antenna includes a plurality of antenna elements. Patent Literature 1 described below describes an antenna including an antenna pattern and a ground pattern. The antenna pattern is provided on one surface of a substrate composed of a dielectric. The ground pattern is provided on another surface of the substrate. The antenna pattern includes a plurality of antenna elements that constitute an array antenna. The ground pattern has an outer shape covering the antenna pattern in transparent plan view.

Patent Literature 1 proposes that the ground pattern be formed over only a portion of the other surface of the substrate instead of the entirety of the other surface, so that the ground pattern does not serve as a source of unnecessary radio waves. Patent Literature 1 also proposes that each antenna pattern be individually provided with a ground pattern as illustrated in FIG. 17 of Patent Literature 1.

Patent Literature 1 does not describe whether radio waves transmitted and received by the antenna elements are linearly polarized waves or circularly polarized waves. The illustrated antenna elements can be regarded as being configured to transmit and receive linearly polarized waves based on the shapes and transmission lines of the antenna elements.

### CITATION LIST

### Patent Literature

Patent Literature 1: Japanese Unexamined Patent Application Publication No. 2020-10240

### SUMMARY

In one aspect of the present disclosure, a circular polarized array antenna includes an antenna layer and a ground layer. The antenna layer includes a plurality of antenna elements disposed at different positions in plan view. Each of the antenna elements is composed of a circular polarized antenna. The ground layer faces the antenna layer. The ground layer includes a plurality of ground patterns separated from each other. Each of the ground patterns faces one or more of the antenna elements.

In one aspect of the present disclosure, an electronic apparatus includes the above-described circular polarized array antenna and an IC. The IC is connected to the circular polarized array antenna.

### BRIEF DESCRIPTION OF THE DRAWINGS

FIG. 1 is a perspective view of a circular polarized array antenna accordingly a first embodiment.

FIG. 2 is a sectional view taken along line II-II in FIG. 1.

FIG. 3A is a plan view of a parasitic patch included in each antenna element of the circular polarized array antenna illustrated in FIG. 1.

FIG. 3B is a plan view of a feed patch included in each antenna element of the circular polarized array antenna illustrated in FIG. 1.

FIG. 3C is a plan view of a ground pattern included in each antenna element of the circular polarized array antenna illustrated in FIG. 1.

FIG. 3D is a transparent plan view of a plurality of conductor layers included in each antenna element of the circular polarized array antenna illustrated in FIG. 1.

FIG. 4A is a graph illustrating the characteristics of gains of antennas according to a comparative example and an example.

FIG. 4B is a graph illustrating the characteristics of axial ratios corresponding to the characteristics of gains illustrated in FIG. 4A.

FIG. 5A is a graph illustrating the characteristics of gains of antennas according to the comparative example and a plurality of examples.

FIG. 5B is a graph illustrating the characteristics of axial ratios corresponding to the characteristics of gains illustrated in FIG. 5A.

FIG. 6A is a plan view of a ground pattern included in each antenna element of a circular polarized array antenna according to a second embodiment.

FIG. 6B is a transparent plan view of a plurality of conductor layers included in the antenna element including the ground pattern illustrated in FIG. 6A.

FIG. 7A is a graph illustrating the characteristics of a gain of an antenna according to an example of the second embodiment.

FIG. 7B is a graph illustrating the characteristics of axial ratios corresponding to the characteristics of gains illustrated in FIG. 7A.

FIG. 8 is a schematic diagram illustrating the structure of an electronic apparatus according to an embodiment.

FIG. 9A is a graph illustrating the characteristics of gains of antennas according to other examples of the second embodiment.

FIG. 9B is a graph illustrating the characteristics of axial ratios corresponding to the characteristics of gains illustrated in FIG. 9A.

FIG. 10A is a graph illustrating the characteristics of gains of each element in the antennas illustrated in FIG. 9A.

FIG. 10B is a graph illustrating the characteristics of axial ratios corresponding to the characteristics of gains illustrated in FIG. 10A.

FIG. 11A is a graph illustrating the characteristics of a gain of an antenna according to another example of the second embodiment.

FIG. 11B is a graph illustrating the characteristics of axial ratios corresponding to the characteristics of gains illustrated in FIG. 11A.

FIG. 12A is a graph illustrating the characteristics of gains of each element in the antennas illustrated in FIG. 11A.

FIG. 12B is a graph illustrating the characteristics of axial ratios corresponding to the characteristics of gains illustrated in FIG. 12A.

### DESCRIPTION OF EMBODIMENTS

Embodiments of the present disclosure will be described with reference to the drawings. The drawings referred to in the following description are schematic, and dimensional ratios and the like in the drawings do not always coincide with the actual ones. Illustration and/or description of details may be omitted. Therefore, for example, a shape referred to as being rectangular may include corners chamfered to a depth such that the antenna characteristics and the like are not greatly affected.

For convenience, an xyz orthogonal coordinate system fixed with respect to an antenna may be illustrated in the drawings and referred to. Any direction relative to the antenna may be upward or downward. For convenience, the term “upper surface”, “lower surface”, or the like may be used assuming that the positive z direction is upward. A plan view is viewed in the z direction unless otherwise specified.

The antenna may be used for transmission and/or reception. However, for convenience, only transmission may be described. In accordance with convention, terms implying transmission, such as “feed point”, may be used irrespective of whether the antenna is used for transmission. In the description of embodiments, the term “wavelength” refers to a wavelength of a radio wave at a frequency of interest of the antenna (for example, the center frequency of a predetermined band) unless otherwise specified.

### First Embodiment

### (Summary of Circular Polarized Array Antenna)

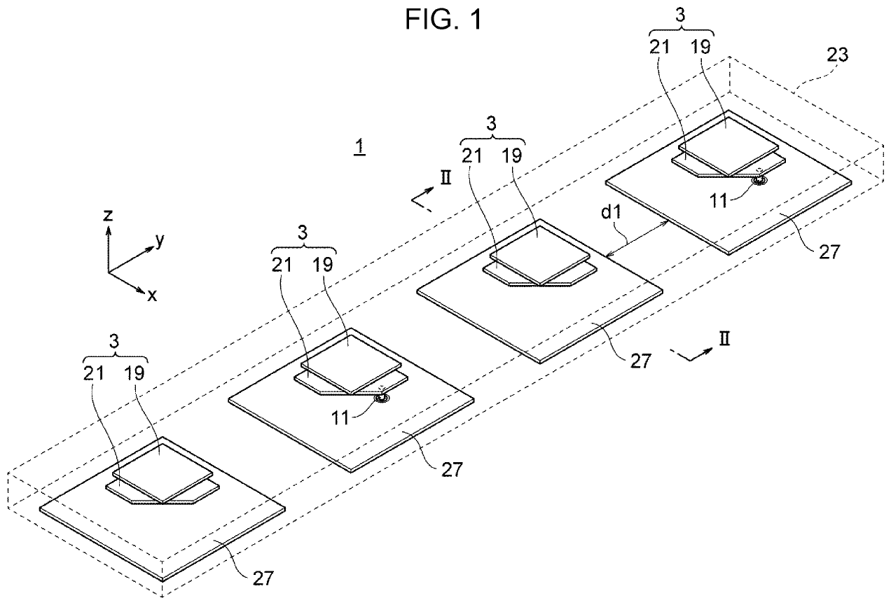

FIG. 1 is a perspective view illustrating the structure of a circular polarized array antenna 1 (hereinafter also referred to simply as an “antenna 1”) according to a first embodiment. In FIG. 1, a portion (dielectric substrate 23 described below) of the antenna 1 is drawn by the dotted lines.

The antenna 1 is capable of transmitting and/or receiving circularly polarized waves. The gain of the antenna 1 is highest in a direction toward the +z side. The direction toward the +z side is not limited to a direction parallel to the z direction, and may be inclined relative to the z direction. The antenna 1 may be used as a phased array antenna, and the direction in which the gain is high may vary. The antenna 1 may be used in any frequency band. In the following description, the antenna 1 may be assumed to be used in a relatively high frequency band. For example, the antenna 1 may be used in a frequency band of 300 MHz or more or 3 GHz or more, and may be used in a frequency band of 30 GHz or less or 300 GHz or less. The lower and upper limits described above may be applied in any combination as appropriate.

The antenna 1 is flat-plate-shaped overall and has a constant thickness. The shape of the antenna 1 illustrated in FIG. 1 in plan view is, for example, simply the shape of a portion of a flat plate (substrate) including the antenna 1, the portion being cut out for the sake of illustration (illustrated side surfaces are cross sections of the above-described substrate). However, the shape illustrated in FIG. 1 in plan view may be the actual shape of the antenna 1 in plan view. In such a case, the antenna 1 may have any shape, for example, a rectangular shape (as illustrated), another polygonal shape, a circular shape, or an elliptical shape, in plan view. A dielectric (for example, a dielectric layer) may be provided on an upper surface and/or a lower surface of the antenna 1. From another perspective, the illustrated plate shape may be the shape of a portion of a member including the antenna 1 (for example, a substrate having a thickness in the z direction). In the description of the present embodiment, the terms “layer” and “plate” are not differentiated.

The antenna 1 may have any appropriate size in accordance with, for example, the frequency band in which the antenna 1 is used. However, as described above, in the description of the present embodiment, the antenna 1 may be assumed to be used in a relatively high frequency band for convenience. The antenna 1 may also be assumed to be relatively small in size. For example, the length of the illustrated area in the x direction (or the length of antenna elements described below in the x direction or the y direction) may be 1 mm or more and 100 mm or less. The length of the illustrated area in the y direction may be 3 mm or more and 300 mm or less. The antenna 1 may have a thickness of, for example, 0.1 mm or more and 10 mm or less. Such a relatively small antenna 1 may be formed as, for example, an electronic component installed in an electronic apparatus. However, the antenna 1 may have a size of several tens of centimeters or more or several meters or more in plan view.

The antenna 1 includes a plurality of antenna elements 3 (four antenna elements 3 in the illustrated example) and is configured as an array antenna. Each antenna element 3 is configured as a circular polarized antenna capable of transmitting and/or receiving a circularly polarized wave. Thus, the antenna 1 is capable of transmitting and/or receiving circularly polarized waves.

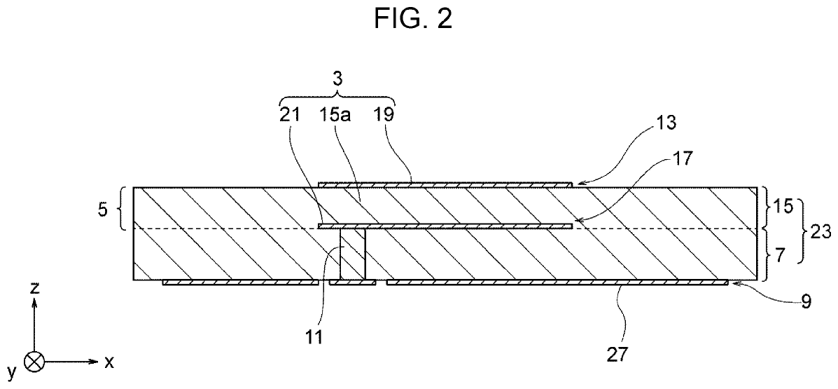

FIG. 2 is a sectional view taken along line II-II in FIG. 1.

The antenna 1 includes, for example, an antenna layer 5, a first dielectric layer 7, and a ground layer 9 in that order from the +z side. The antenna 1 also includes a plurality of feed vias 11 (see FIG. 1) extending through the first dielectric layer 7. The antenna layer 5 includes the antenna elements 3 and directly contribute to transmission and/or reception of radio waves. The ground layer 9 is a layer that receives a reference potential, and constitutes a ground plate. The first dielectric layer 7 contributes to, for example, supporting and insulating the antenna layer 5 and the ground layer 9. The feed vias 11 contribute to feeding power to the antenna layer 5.

The structure of the antenna 1 excluding the ground layer 9 may be the same as and/or similar to the structure of a known circular polarized array antenna (or, of course, a new structure). In the following description, description of a structure that may be the same as and/or similar to a known structure may be omitted as appropriate.

The antenna layer 5 includes, for example, a first conductor layer 13, a second dielectric layer 15, and a second conductor layer 17 arranged in that order from the +z side. As illustrated in FIGS. 1 and 2, the first conductor layer 13 includes a plurality of parasitic patches 19, each of which is included in one of the antenna elements 3. The second conductor layer 17 includes a plurality of feed patches 21, each of which is included in one of the antenna elements 3.

As illustrated in FIG. 2, the first dielectric layer 7 and the second dielectric layer 15 may be regarded as constituting a dielectric substrate 23. Each portion of the second dielectric layer 15 overlapping one of the parasitic patches 19 and one of the feed patches 21 may be regarded as an individual dielectric layer 15a provided for each antenna element 3.

In the following description, first, the structures of components other than the ground layer 9 will be described. Then, the structure of the ground layer 9 will be described.

### (Conductors)

The thicknesses of the conductor layers (e.g., the first conductor layer 13, the second conductor layer 17, and the ground layer 9) and the shape and dimensions of the axial conductors (feed vias 11) crossing the conductor layers may be set as appropriate in accordance with, for example, the characteristics of the antenna 1. The thicknesses of the conductor layers may be less than the thicknesses of the dielectric layers (e.g., the first dielectric layer 7 and the second dielectric layer 15). The thicknesses of the conductor layers may be, for example, 1 μm or more and 1 mm or less.

The materials of the various conductor members (e.g., the first conductor layer 13, the second conductor layer 17, the ground layer 9, and the feed vias 11) may be, for example, a metal. The metal may be any appropriate metal, such as Cu or Al. The various conductor members may be made of the same material or different materials. Each conductor member may be made of a single material or a plurality of materials. A conductor member made of a plurality of materials may be, for example, a conductor layer formed by stacking layers made of different materials.

In view of the materials, for example, a connection portion between a conductor layer (for example, the second conductor layer 17) and an axial conductor (for example, one of the feed vias 11) orthogonal to the conductor layer may be formed such that an end surface of the axial conductor is bonded to an upper or lower surface of the conductor layer, or such that the axial conductor extends through the conductor layer. Alternatively, the connection portion may be formed in a manner that is not distinguishable as described above. In the following description, for convenience, the axial conductor may be assumed to be bonded to an upper or lower surface of the conductor layer.

### (Dielectric Layer)

The above description of the shape and dimensions of the antenna 1 in plan view may be applied to the shape and dimensions of the dielectric substrate 23 (from another perspective, the first dielectric layer 7 and the second dielectric layer 15) in plan view. The thickness of each dielectric layer may be set as appropriate so that the antenna has improved characteristics. The setting method may, for example, be the same as and/or similar to the setting method for a known patch antenna.

The first dielectric layer 7 and the second dielectric layer 15 may be made of the same material or different materials. Each dielectric layer may be made of a single material or a plurality of materials. When one dielectric layer is made of a plurality of materials, the one dielectric layer may be formed by, for example, stacking dielectric layers made of different materials in the thickness direction and/or impregnating a base material made of glass cloth or the like with a dielectric. The material of the dielectric layer (dielectric) may be, for example, a ceramic and/or a resin.

### (Antenna Elements)

As described above, each antenna element 3 may include various structures capable of transmitting and/receiving a circularly polarized wave. For example, each antenna element 3 may be a patch antenna, a linear antenna (for example, a dipole antenna or a loop antenna), or a slot antenna. In the present embodiment, a patch antenna will be described as an example.

Examples of a patch antenna capable of transmitting and/or receiving a circularly polarized wave include a two-point-feed square patch antenna and a one-point-feed patch antenna. The one-point-feed patch antenna includes a conductive patch (for example, a feed patch) having, for example, a rectangular shape, a square shape with a pair of chamfered corners, or a circular shape with a pair of projections or a pair of recesses.

The patch may be, for example, a half-wavelength patch. The half-wavelength patch is a patch having a shape with a size based on ½×λg in plan view. Here, λg is an effective wavelength at a location of the patch determined in accordance with, for example, the dielectric constant of the dielectric substrate 23. For example, the length of each side of a two-point-feed square patch antenna is theoretically ½×λg. For example, the lengths of a one-point-feed patch antenna in directions of vibration of two linearly polarized waves constituting a circularly polarized wave may be theoretically set to lengths greater than and less than ½×λg.

An example of the structure of each antenna element 3 according to the present embodiment will now be described.

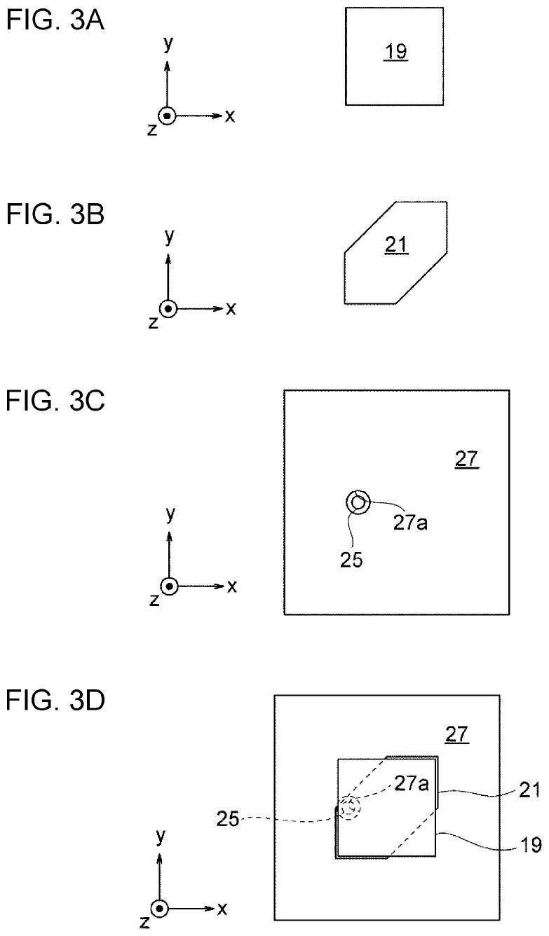

FIG. 3A is a plan view of the parasitic patch 19. FIG. 3B is a plan view of the feed patch 21. FIG. 3D is a transparent plan view of the antenna element 3. FIG. 3D illustrates a conductor and the ground layer 9 of the antenna element 3.

In the illustrated antenna element 3, the shape of the feed patch 21 in plan view is obtained by relatively deeply chamfering a pair of corners of a square. The parasitic patch 19 has a square shape in plan view. The feed patch 21 and the parasitic patch 19 are disposed such that geometric centers thereof coincide with each other. The feed patch 21 is provided with a feed point (connected to the corresponding feed via 11) at a location (see the location of a pad 25 in FIG. 3D) around the center of one side of the square serving as a base.

When the feed patch 21 receives an alternating current, an electric field vibrates in directions along two diagonals of the square serving as a base so that linearly polarized waves having different frequencies are generated. Accordingly, an elliptically polarized wave (having an axial ratio of, for example, 10 dB or more) is generated. The parasitic patch 19 serves to improve the axial ratio of the elliptically polarized wave to change the elliptically polarized wave into a wave closer to a circularly polarized wave (having an axial ratio of, for example, 3 dB or less). The axial ratio (AR) is an index representing how close a wave is to a circularly polarized wave. When EL is an electric field intensity of a left-hand circularly polarized wave and ER is an electric field intensity of a right-hand circularly polarized wave, the axial ratio is expressed as AR=(|EL|+|ER|)/(|EL|−|ER|). Therefore, the axial ratio is expressed in dB, which is a unit of electric field intensity.

Unlike the illustrated example, the feed patch 21 itself may generate a circularly polarized wave (having an axial ratio of, for example, 3 dB or less). For example, the feed patch 21 may be chamfered to a depth less than that in the illustrated example. The parasitic patch 19 (and the second dielectric layer 15) may be omitted, or be provided mainly for another purpose. The other purpose may be, for example, broadening of the band.

Power may be fed to the feed patch 21 by any appropriate method. In the illustrated example, power is fed through the feed via 11 connected to the lower surface of the feed patch 21. As an example other than the illustrated example, the second conductor layer 17 may include a feed line (microstrip line) extending from the feed patch 21, and the feed via 11 may be connected to the feed line.

### (Positional Relationship and Other Features of Antenna Elements)

The number of antenna elements 3 and the positional relationship between the antenna elements 3 may be set as appropriate. For example, the number of antenna elements 3 may be two, or three or more. The antenna elements 3 may be arranged in one row, or in two or more rows. The number of antenna elements 3 or the positional relationship between the antenna elements 3 may be such that no rows are recognizable. The antenna elements 3 may be arranged in rows and columns, in a staggered pattern, or in a radial and/or concentric pattern.

When the antenna elements 3 are arranged in a certain direction, the pitch between the antenna elements 3 may or may not be constant. The pitch is, for example, the distance between geometric centers of adjacent ones of the patches in plan view. The pitch may be set to any appropriate size. For example, provided that the patches are separated from each other, the pitch may be in the range of 3/10 or more and 9/10 or less of a wavelength in free space, or outside this range. For example, the pitch may be in the range of 6/10 of the effective wavelength λg or more and twice the effective wavelength λg or less, or outside this range.

In plan view, the orientations of the antenna elements 3 (orientations of the shapes of the patches and/or orientations relative to the feed points) may be the same or different from each other. The antenna elements 3 may or may not be arranged and controlled to form a sequential rotation array antenna.

In the example illustrated in FIG. 1, the orientations of adjacent ones of the antenna elements 3 relative to the feed points (feed vias 11) differ from each other by 180° in plan view. In this case, for example, the adjacent ones of the antenna elements 3 receive currents in phases that differ from each other by 180°. This enables structures for feeding power to be disposed at alternate sides, for example, and therefore the size of the antenna 1 may be advantageously reduced. Unlike the illustrated example, the orientations of adjacent ones of the antenna elements 3 relative to the feed points may be the same. In this case, for example, the circuit structure can be simplified because currents in the same phase may be supplied to the antenna elements 3.

### (Ground Layer)

As illustrated in FIGS. 1 and 2, the ground layer 9 includes a plurality of ground patterns 27 provided for respective ones of the antenna elements 3. In other words, the ground layer 9 does not extend over the antenna elements 3 but is divided into portions corresponding to respective ones of the antenna elements 3. In this case, for example, the antenna 1 transmits circularly polarized waves with an improved axial ratio.

In the illustrated example, the ground patterns 27 are completely separated from each other in the ground layer 9. However, the term “separated” does not necessarily mean that the ground patterns 27 are completely separated from each other in the ground layer 9 as in the illustrated example. For example, when a width is a dimension in a direction (x direction in the illustrated example) orthogonal to a direction in which the ground patterns 27 are arranged, adjacent ones of the ground patterns 27 may be electrically connected to each other by a wiring line having a width less than the width (for example, maximum width) of the ground patterns 27. Thus, the term “separated” used herein may mean that, for example, a gap is formed between the ground patterns 27. When a wiring line is provided as described above, the width of the wiring line may be ½ or less, ⅓ or less, or ⅕ or less of the width of the ground patterns 27.

FIG. 3C is a plan view of one of the ground patterns 27.

As in the illustrated example, each ground pattern 27 may include an opening 27a so that the ground pattern 27 is not short-circuited to the feed via 11 and/or the pad 25 connected to the feed via 11. The material and thickness of the pad 25 may be the same as those of the ground layer 9. In other words, the ground layer 9 and the pad 25 may be included in the same conductor layer. The material and/or thickness of the pad 25 may be different from those of the ground layer 9, and the pad 25 may be omitted.

As described above, the second conductor layer 17 may include a transmission line extending from the feed patch 21. The feed via 11 may be connected to an end portion of the transmission line opposite to an end portion adjacent to the feed patch 21. In this case, the feed via 11 may be disposed outside the ground pattern 27. In other words, the ground pattern 27 may include no opening 27a. In the description of the present embodiment, for convenience, the opening 27a may be ignored irrespective of whether the opening 27a is present or absent.

Each ground pattern 27 may have any appropriate shape. In the illustrated example, each ground pattern 27 has a square shape in plan view. The shape of each ground pattern 27 in plan view may be a rectangular shape, a polygonal shape other than a rectangular shape, a circular shape, an elliptical shape, or a combination thereof. The ground patterns 27 may, for example, have the same shape.

As described above, in the example illustrated in FIG. 1, adjacent ones of the antenna elements 3 are provided with the feed vias 11 disposed at different positions. Accordingly, in the example illustrated in FIG. 1, adjacent ones of the ground patterns 27 include the openings 27a disposed at different positions. However, as is clear from the above description, adjacent ones of the ground patterns 27 may include the openings 27a disposed at the same position.

Each ground pattern 27 may have any appropriate size. For example, each ground pattern 27 may have a size (and shape) such that, for example, the ground pattern 27 covers the corresponding antenna element 3 (from another perspective, the feed patch 21 and/or the parasitic patch 19; this applies throughout this section) in transparent plan view. When each ground pattern 27 is described as covering the corresponding antenna element 3, the outer edge of the ground pattern 27 may, for example, be positioned entirely outside the outer edge of the antenna element 3 or partially overlap the outer edge of the antenna element 3.

Assume that a diameter of each ground pattern 27 is a length of a segment extending through a geometric center of the ground pattern 27 and including ends on the outer edge of the ground pattern 27 (this also applies to the patches and other elements). In this case, the minimum diameter or the maximum diameter of each ground pattern 27 may be equal to or greater than a maximum diameter of each antenna element 3 (from another perspective, the feed patch 21 and/or the parasitic patch 19). The minimum diameter and/or the maximum diameter of each ground pattern 27 may be in the range of ¼ of the wavelength in free space or more and the wavelength in free space or less, or outside this range. For example, the minimum diameter and/or the maximum diameter of each ground pattern 27 may be in the range of ½ of the effective wavelength λg or more and twice the effective wavelength λg or less, or outside this range.

In transparent plan view, each ground pattern 27 may be in any appropriate positional relationship with the corresponding antenna element 3. For example, the geometric center of each ground pattern 27 may coincide with the geometric center of the corresponding feed patch 21 and/or the geometric center of the corresponding parasitic patch 19 (as illustrated), or be displaced from the geometric center of the corresponding feed patch 21 and/or the geometric center of the corresponding parasitic patch 19.

The pitch between the ground patterns 27 may, for example, be equal to the pitch between the antenna elements 3. However, for example, the pitch between the ground patterns 27, each of which covers the corresponding antenna element 3 in transparent plan view, may differ from the pitch between the antenna elements 3 in a certain region.

A distance d1 between adjacent ones of the ground patterns 27 (see FIG. 1; in other words, the size of a gap; for example, the minimum distance) may be set as appropriate. For example, the distance d1 may be equal to or greater than the minimum distance at which dielectric breakdown does not occur when an expected electric field is generated in the ground patterns 27. For example, the distance d1 may be equal to or greater than 1/10 of the maximum diameter of each antenna element 3 (from another perspective, the feed patch 21 and/or the parasitic patch 19) in plan view, and equal to or less than the maximum diameter of each antenna element 3 in plan view.

A reference potential may be applied to the ground patterns 27 by any appropriate method. For example, the ground patterns 27 may be electrically connected to a signal ground and/or a frame ground through a conductor of a circuit board on which the antenna 1 is mounted and/or a conductor of a circuit board including the antenna 1. The above-described conductor of the circuit board may be provided for each of the ground patterns 27 or for one or more of the ground patterns 27. When the conductor is provided for one or more of the ground patterns 27, the ground patterns 27 may be connected to each other by a wiring line included in the ground layer 9 as described above.

As described above, the circular polarized array antenna 1 includes the antenna layer 5 and the ground layer 9 facing the antenna layer 5. The antenna layer 5 includes the antenna elements 3 at different locations in plan view. Each antenna element 3 is composed of a circular polarized antenna. The ground layer 9 includes the ground patterns 27 that are separated from each other such that each ground pattern 27 faces one or more of the antenna elements 3.

In this case, for example, the circularly polarized wave has an improved axial ratio compared to when the ground layer 9 extends over all of the antenna elements 3 without gaps. A reason for this may be that a large ground plate provides an effect of relatively increasing the gain of a linearly polarized wave forming a major axis of an elliptically polarized wave while the divided ground layer 9 serves to reduce this effect.

The ground patterns 27 may face the antenna elements 3 in one-to-one correspondence. In this case, for example, as is clear from the above-described reason for the improvement in the axial ratio, the effect of improving the axial ratio is enhanced compared to when each ground pattern 27 overlaps two or more of the antenna elements 3 (this configuration may also be included in the art of the present disclosure).

Each ground pattern 27 may cover one or more of the antenna elements 3 in transparent plan view. Each ground pattern 27 may cover one of the antenna elements 3 in transparent plan view (one-to-one correspondence). In this case, for example, each antenna element 3 has improved characteristics compared to when the antenna element 3 includes a portion that does not overlap the corresponding ground pattern 27 in transparent plan view (this configuration may also be included in the art of the present disclosure).

Each ground pattern 27 may have a square shape in plan view. In this case, for example, the structure of the ground patterns 27 is simple and easy to design. Since the ground patterns 27 are not elongated in any specific direction, as is clear from the above-described reason for the improvement in the axial ratio due to the divided ground layer 9, the axial ratio can be easily improved.

At least some of the antenna elements 3 may be arranged in a first direction (y direction). A maximum length of each ground pattern 27 in the y direction may be equal to the maximum length of the ground pattern 27 in a second direction (x direction) orthogonal to the y direction. In this case, for example, the axial ratio can be easily improved as in the above-described case in which each ground pattern 27 has a square shape.

The distance d1 between adjacent ones of the ground patterns 27 may be equal to or greater than 1/10 of the maximum diameter of each antenna element 3 in plan view. In this case, the distance d1 is sufficiently large, and the divided ground layer 9 easily provides the effect of improving the axial ratio.

The minimum diameter of each ground pattern 27 may be equal to or greater than the maximum diameter of each antenna element 3 in plan view. In this case, for example, the ground patterns 27 are separated from each other but have a sufficiently large area as compared with the area of the antenna elements 3. As a result, for example, the characteristics of the antenna can be easily improved.

### Example of First Embodiment

Simulation calculations were performed to study the characteristics of antennas according to a comparative example and an example. As a result, the improvement in the axial ratio due to the divided ground layer 9 was confirmed. This will be further described below.

Conditions common to the comparative example and the example will now be described. The frequency of interest was 28 GHz. The wavelength λ in free space at this frequency is about 10.7 mm. Each antenna included four antenna elements 3 arranged in one row as illustrated in FIG. 1. The pitch between the antenna elements 3 was constant at ¾×λ. The parasitic patches 19 had a square shape with sides of about 2.4 mm. The feed patches 21 had a shape based on a square with sides of about 2.5 mm and obtained by chamfering the square serving as a base to reduce the length of each side by about 1.2 mm. The distance between each feed patch 21 and the corresponding parasitic patch 19 was 0.4 mm. The distance between each feed patch 21 and the ground layer was 0.5 mm. The relative dielectric constant of the dielectric substrate 23 was about 3.28.

Conditions that differ between the comparative example and the example will now be described. In the comparative example, the ground layer was a single solid pattern (basically a pattern extending without a gap) covering the four antenna elements 3 in transparent plan view. In the example, as illustrated in FIG. 1, the ground layer 9 included the plurality of ground patterns 27 (four ground patterns 27 herein), each ground pattern 27 covering one of the antenna elements 3 in transparent plan view. The ground patterns 27 had a square shape with sides of about 5.4 mm. As illustrated in FIG. 3D, the geometric center of each ground pattern 27 coincided with the geometric center of the corresponding feed patch 21 and the geometric center of the corresponding parasitic patch 19. The dimensional ratios illustrated in FIG. 3A to 3D are in accordance with the dimensions of the example herein.

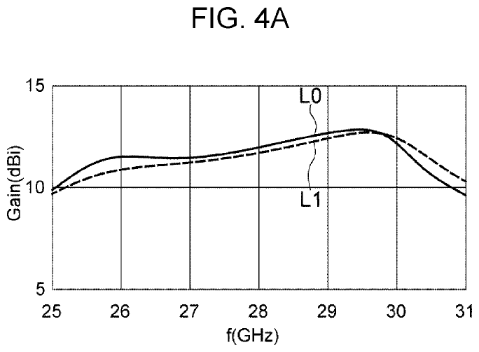

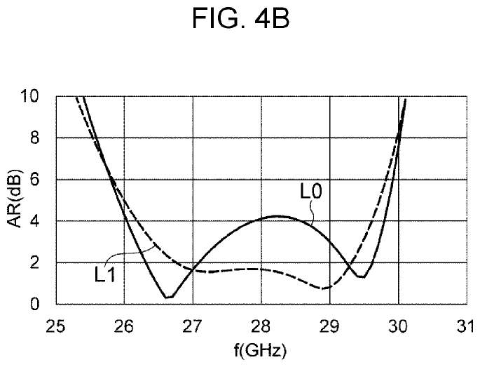

FIGS. 4A and 4B are graphs illustrating the characteristics of the antennas according to the comparative example and the example. In FIGS. 4A and 4B, the horizontal axis represents the frequency f (GHz). In FIG. 4A, the vertical axis represents the gain (dBi). In FIG. 4B, the vertical axis represents the axial ratio (abbreviated as AR; unit is dB). In the graphs, curve L0 represents the characteristics of the comparative example. Curve L1 represents the characteristics of the example.

As illustrated in FIG. 4A, according to the example, the gain is similar to the gain according to the comparative example. Although the gain according to the example is somewhat less than the gain according to the comparative example in a band centered at 28 GHz, the difference is relatively small. In the graph, the difference in gain is about 0.3 dBi at 28 GHz.

As illustrated in FIG. 4B, according to the example, the axial ratio is improved compared to that according to the comparative example. More specifically, in the graph, the comparative example has a local maximum at a frequency around 28 GHz. In contrast, according to the example, the curve including the local maximum is smoothed so that the axial ratio is closer to 0 dB than the axial ratio according to the comparative example. More specifically, the axial ratio according to the example is less than the axial ratio according to the comparative example by about 2.4 dB at a frequency around 28 GHz. According to the example, since the curve including the local maximum of the axial ratio is smoothed, the band in which the axial ratio is 3 dB or less, for example, is broader than that according to the comparative example.

### Other Examples of First Embodiment

Simulation calculations were also performed to determine the gains and the axial ratios for examples in which the distance d1 between the ground patterns 27 was changed from that in the above-described example. As a result, the improvement in the axial ratio was confirmed for various distances d1. This will be further described below.

The distance d1 between the ground patterns 27 was changed in the range of 0λ to 8/16×λ in steps of λ/16 under the conditions basically the same as and/or similar to those in the above-described example in FIGS. 4A and 4B, and the gain and the axial ratio were calculated for each case. The distance d1 was changed without changing the pitch between the ground patterns 27 (¾×λ herein) and the shape of the ground patterns 27 (square herein). The size of the ground patterns 27 was changed in accordance with the change in the distance d1.

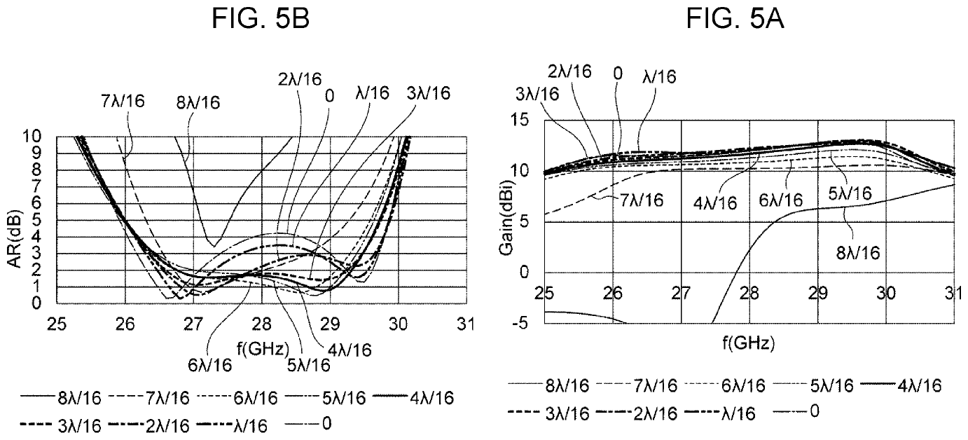

FIGS. 5A and 5B are graphs illustrating the calculation results. FIG. 5A illustrates the gains as in FIG. 4A. FIG. 5B illustrates the axial ratios as in FIG. 4B. The legend lists the distances d1 based on λ. The case in which the distance d1 is “0” corresponds to the comparative example illustrated in FIGS. 4A and 4B. The case in which the distance d1 is “4λ/16” corresponds to the example illustrated in FIGS. 4A and 4B.

As illustrated in FIG. 5A, when the distance d1 is relatively small, the gains according to the examples are generally equivalent to the gain according to the comparative example. When the distance d1 exceeds a certain distance (for example, 7/16×λ), the difference between the gain according to each example and the gain according to the comparative example increases. This may be because an electric field different from an expected electric field is generated due to a reduction in the size of the ground patterns 27.

As illustrated in FIG. 5B, a simple change in the distance d1 from “0” to “λ/16” causes an improvement in the axial ratio. In other words, the divided ground layer 9 provides an improvement in the axial ratio even when the distance d1 is small. In the graph, as the distance d1 increases from “λ/16”, the axial ratio is further improved. However, when the distance d1 reaches “8λ/16”, the axial ratio is degraded.

The distance d1 (and/or the size of the ground patterns 27) may have a lower limit and/or an upper limit as appropriate based on the above-described tendency.

For example, referring to the graphs, the distance d1 may be in the range of 2/16×λ or more and 4/16×λ or less. In this case, in a band having a width of 3 GHz and centered at 28 GHz, the axial ratio is 3 dB or less and the gain is 11 dBi or more.

As described above, the axial ratio improves even when the distance d1 is λ/16. Here, λ/16 is about 0.67 mm. The maximum diameter of each antenna element 3 is the length of a diagonal of each feed patch 21, and is about 3.5 mm. Therefore, the distance d1 may be, for example, 1/10 or more or ⅕ or more of the maximum diameter of each antenna element 3.

The reduction in the gain and/or the degradation of the axial ratio caused when the distance d1 is increased may be due to the size of the ground patterns 27 as described above. When the distance d1 is “8λ/16”, the length of each side (from another perspective, the minimum diameter) of each ground pattern 27 is about 2.7 mm. When the distance d1 is “7λ/16”, the length of each side of each ground pattern 27 is about 3.3 mm. The length of each side of the square serving as a base of each feed patch 21 is about 2.5 mm, and the maximum diameter (length of the diagonal) of each feed patch 21 is about 3.5 mm. Therefore, the minimum diameter of each ground pattern 27 may, for example, be equal to or greater than the length of each side of each antenna element 3, or equal to or greater than the maximum diameter of each antenna element 3.

### Second Embodiment

In the description of the second embodiment, differences from the first embodiment will be basically described. Features that are not specifically described may be the same as and/or similar to those of the first embodiment, or be understood by analogy to those of the first embodiment.

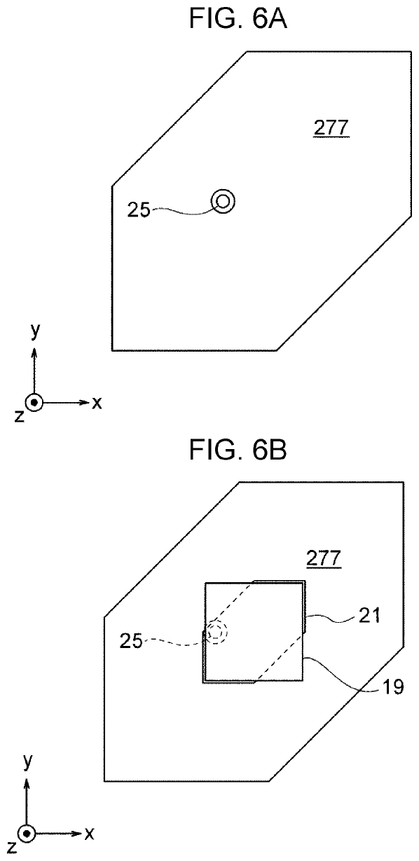

FIG. 6A is a plan view of a ground pattern 227 included in an antenna according to a second embodiment. FIG. 6A corresponds to FIG. 3C in the first embodiment. FIG. 6B is a transparent plan view of the antenna according to the second embodiment. FIG. 6B corresponds to FIG. 3D in the first embodiment.

As described in the first embodiment, each ground pattern may have any appropriate shape. The ground pattern 227 according to the second embodiment has a shape obtained by chamfering a pair of corners of a square. When chamfers are formed in this manner, the axial ratio is further improved. A reason for this is that a current distribution formed in the ground pattern 227 changes from that of a linearly polarized wave toward that of a circularly polarized wave.

The position, shape, depth, and the like of the chamfers may be set as appropriate. For example, among the two pairs of opposite corners, the pair of chamfered opposite corners may be the opposite corners facing each other in a direction of the minimum diameter of the antenna element 3 (in the illustrated example, the direction in which the chamfered opposite corners of the feed patch 21 face each other). The two chamfers may, for example, have the same shape and depth. For example, the square serving as a base may be chamfered along straight lines so as to remove isosceles triangles. The square serving as a base may have any appropriate size and may be chamfered to any appropriate depth. For example, the chamfer depth may be in a range such that the length of each side of the square serving as a base is reduced by ⅓ or more and ⅔ or less, or outside this range.

### Examples of Second Embodiment

Simulation calculations were performed to study the characteristics of the antenna according to the second embodiment by setting the materials, dimensions, and the like. As a result, according to the second embodiment, both the gain and the axial ratio of the antenna were improved compared to those of the antennas according to the first embodiment. This will be further described below.

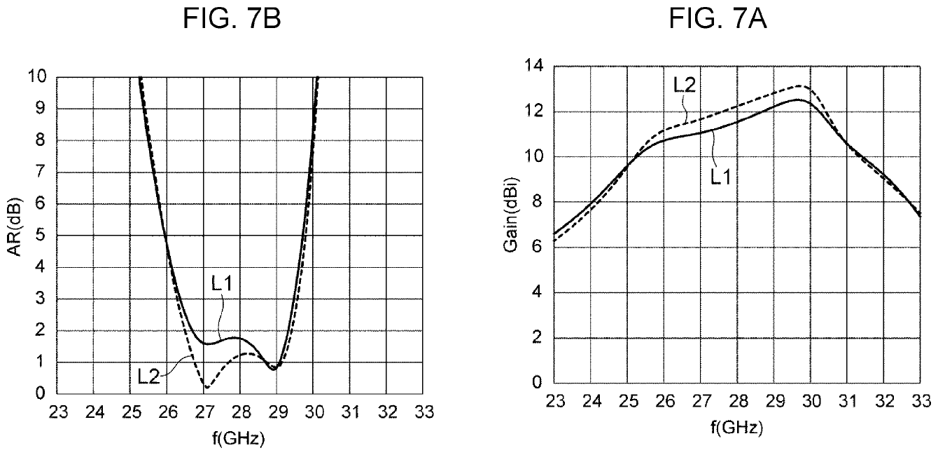

FIGS. 7A and 7B are graphs illustrating the characteristics of the antennas according to examples as in FIGS. 4A and 4B, respectively. In the graphs, curve L1 represents the characteristics of an example of the first embodiment. Curve L2 represents the characteristics of an example of the second embodiment. Except for the shape and size of the ground pattern, conditions of the two examples are the same, and are the same as the conditions of the example of the first embodiment described above with reference to FIGS. 4A and 4B, for example.

The example of the first embodiment having the characteristics represented by curve L1 (hereinafter also referred to as a “first example”) is one of the above-described examples of the first embodiment (examples with different distances d1) having the best characteristics. The first example is the example illustrated in FIGS. 4A and 4B, and is also the example with the distance d1 of 4/16×λ in FIGS. 5A and 5B.

The example of the second embodiment having the characteristics represented by curve L2 (hereinafter also referred to as a “second example”) is one of examples of the second embodiment (examples with different distances d1 and different chamfer depths) having the best characteristics. In the second example, the length of each side of the square serving as a base of the ground pattern 227 is about 7.5 mm. The chamfer depth is such that the length of each side of the square is reduced by about 3.2 mm. The distance d1 is about 0.5 mm. The dimensional ratios illustrated in FIGS. 6A and 6B are in accordance with the dimensions of the second example.

As illustrated in FIGS. 7A and 7B, according to the second example, the gain and the axial ratio are improved compared to those according to the example of the first embodiment. More specifically, at 28 GHz, the gain is improved by 0.2 dBi, and the axial ratio is improved by 0.5 dB.

According to the second example, the distance d1 is relatively small. For example, the distance d1 of about 0.5 mm is about 1/20 of the wavelength λ in free space (about 10.7 mm). The distance d1 is about 1/7 of the maximum diameter of each antenna element 3 in plan view (length of a diagonal of each feed patch 21: about 3.5 mm). Thus, the distance d1 may be relatively small (for example, 1/10 or more of the maximum diameter of each antenna element 3).

### Another Example of Second Embodiment

The above-described second example differs from the first example not only in that the corners of the ground pattern are chamfered, but also in the distance d1 (from another perspective, the dimensions of a square serving as a base that is not chamfered). The following description describes the characteristics of an example of the second embodiment that differs from the first example only in that the corners are chamfered (hereinafter also referred to as a “third example”). In the third example, the chamfer depth is such that the length of each side of the square is reduced by about 1.6 mm, and is smaller than the chamfer depth in the second example.

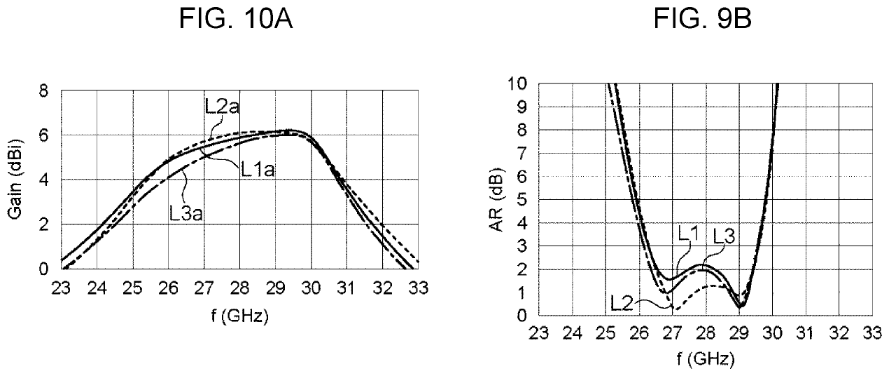

FIGS. 9A and 9B are graphs illustrating the characteristics of the antennas according to the examples as in FIGS. 7A and 7B, respectively. In the graphs, curve L1 represents the characteristics of the first example. Curve L2 represents the characteristics of the second example. Curve L3 represents the characteristics of the third example.

Strictly speaking, the examples illustrated in FIGS. 9A and 9B somewhat differ from the examples illustrated in FIGS. 7A and 7B in the dimensions of the dielectric substrate 23 in plan view. As a result, the characteristics in FIGS. 9A and 9B somewhat differ from those in FIGS. 7A and 7B. However, correlations between the examples in the band of interest (band having a width of about 3 GHz and centered at 28 GHz) do not substantially differ between FIGS. 9A and 9B and FIGS. 7A and 7B. Therefore, for convenience, the names “first example” and “second example” are used in both cases.

As illustrated in FIGS. 9A and 9B, at the frequency of interest (around 28 GHz), the gain according to the third example is equivalent to that according to the first example, and the axial ratio according to the third example is improved compared to that according to the first example. However, according to the third example, the amount of improvement in the axial ratio is less than that according to the second example, and the gain is less than that according to the second example. More specifically, at a frequency around 28 GHz, the gain is 11.6 dBi (first example), 12.3 dBi (second example), and 11.6 dBi (third example), and the axial ratio is 2.1 dBi (first example), 1.2 dBi (second example), and 1.9 dBi (third example).

As is clear from the above discussion, the axial ratio can be improved by forming chamfers. Assuming, for example, that the chamfer depth according to the third example is an example of a lower limit, the lower limit is as follows. That is, in the third example, an isosceles triangle is removed from each corner so that the length of each side of a square (about 5.4 mm) is reduced by about 1.6 mm. The wavelength λ in free space is about 10.7 mm. Therefore, the amount by which the length of each side of the square is reduced as a result of chamfering of the square may be 0.3 times the length of each side of the square or more (1.6 mm/5.4 mm or more), or 0.15λ or more (1.6 mm/10.7 mm×λ or more).

As is clear from the above discussion, as the chamfer depth increases, the axial ratio and the gain can be more easily improved. From another perspective, as the chamfer depth increases, the distance d1 can be more easily reduced (the size of the square serving as a base can be more easily increased). For example, in the second example, the amount by which the length of each side of the square is reduced as a result of chamfering of the square is about 0.3λ (3.2 mm/10.7 mm×λ). Therefore, the amount by which the length of each side of the square is reduced as a result of chamfering of the square may be equal to or greater than a value between the values according to the second and third examples, and may be, for example, 0.20λ or more or 0.25λ or more. The upper limit may be, for example, less than ½ of the length of each side of the square.

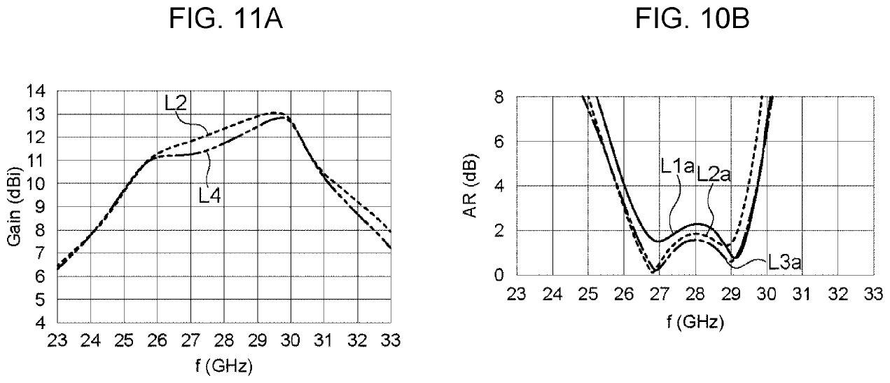

FIGS. 10A and 10B are graphs illustrating the characteristics of antennas (hereinafter also referred to as “single antennas”) obtained by extracting a portion having a size generally corresponding to the size of one antenna element 3 from each of the antennas according to the first to third examples. The horizontal and vertical axes in FIGS. 10A and 10B are the same as and/or similar to the horizontal and vertical axes in FIGS. 9A and 9B. Curves L1a, L2a, and L3a respectively correspond to the antennas of the first, second, and third examples.

As is clear from the comparison between FIGS. 9A and 10A, unlike the case of the array antennas, in the case of the single antennas, the gain according to the third example is less than the gain according to the first example at the frequency of interest (around 28 GHz). In the case of the single antennas, the gain according to the second example is greater than the gain according to the first example at the frequency of interest, but the difference therebetween is smaller than that in the case of the array antennas. More specifically, at a frequency around 28 GHz, the gain is 5.9 dBi (first example), 6.1 dBi (second example), and 5.6 dBi (third example).

As is clear from the comparison between FIGS. 9B and 10B, unlike the case of the array antennas, in the case of the single antennas, the axial ratio according to the third example is further improved than the axial ratio according to the second example at the frequency of interest. More specifically, at a frequency around 28 GHz, the axial ratio is 2.3 dBi (first example), 1.8 dBi (second example), and 1.6 dBi (third example).

As described above, within the examples described herein, the effect of improving the axial ratio while maintaining (or improving) the gain by chamfering the corners can be provided more easily in the case of the array antennas than in the case of the single antennas. In the case of the single antennas, the axial ratio is not always improved as the chamfer depth is increased. In other words, the above-described example of the lower limit for relatively deep chamfers (0.20λ or 0.25λ) does not apply to the single antennas.

### Still Another Example of Second Embodiment

In the second example, the pair of chamfered opposite corners of the ground pattern is one of two pairs of opposite corners of a square that is in the same direction as the direction of the pair of chamfered opposite corners of the feed patch 21. The following description describes the characteristics of an example in which the pair of chamfered opposite corners of the ground pattern is the other pair of opposite corners (hereinafter also referred to as a “fourth example”). The fourth example is the same as and/or similar to the second example except for the direction of the pair of opposite corners.

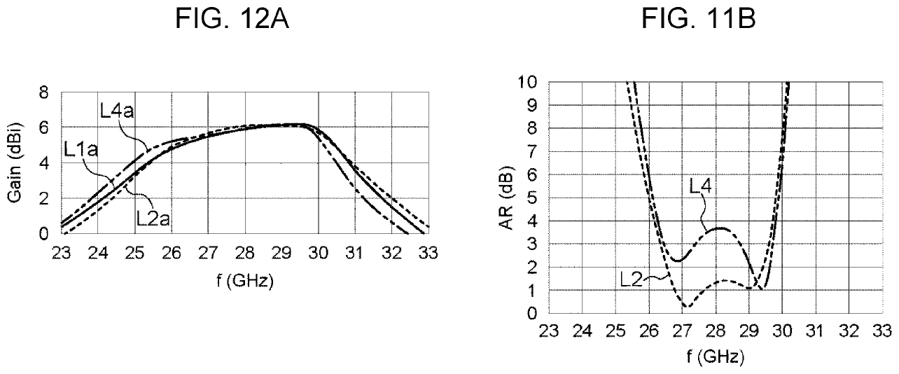

FIGS. 11A and 11B are graphs illustrating the characteristics of antennas according to examples as in FIGS. 9A and 9B, respectively. In the graphs, Curve L2 is the same as and/or similar to those in FIGS. 9A and 9B. Curve L4 represents the characteristics of the fourth example.

As illustrated in the graphs, according to the fourth example, the gain is less than that according to the second example, and the axial ratio is farther from 1 than that according to the second example at a frequency around the frequency of interest (28 GHz). Thus, assuming that a feed patch 21 including a pair of chamfered opposite corners and a ground pattern 227 including a pair of chamfered opposite corners are combined, the gain and the axial ratio can be more easily improved when the pair of chamfered opposite corners of the feed patch 21 and the pair of chamfered opposite corners of the ground pattern 227 are in the same direction.

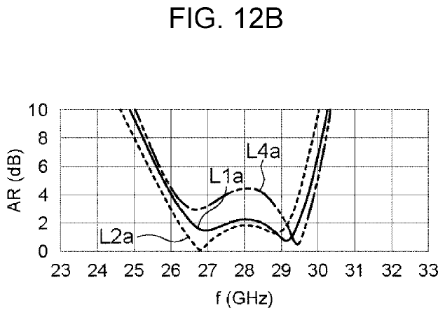

FIGS. 12A and 12B are graphs illustrating the characteristics of single antennas as in FIGS. 10A and 10B, respectively. Curves L1a and L2a are the same as and/or similar to those in FIGS. 9A and 9B. Curve L4a corresponds to the antenna according to the fourth example.

As is clear from the comparison between FIGS. 11A and 12A, unlike the case of the array antennas, in the case of the single antennas, the gain according to the fourth example is substantially equivalent to the gain according to the second example at a frequency around the frequency of interest (28 GHz). More specifically, at a frequency around 28 GHz, the gain of the single antenna is 5.9 dBi (first example), 6.1 dBi (second example), and 5.9 dBi (fourth example). As is clear from the comparison between FIGS. 11B and 12B, the relationship between the axial ratio according to the second example and the axial ratio according to the fourth example in the case of the array antennas is the same as and/or similar to that in the case of the single antennas.

As is clear from the above discussion, within the examples described herein, the effect of improving the axial ratio while maintaining (or improving) the gain by aligning the direction of the chamfers of the ground pattern with the direction of the chamfers of the feed patch 21 can be provided more easily in the case of the array antennas than in the case of the single antennas.

### <Applications>

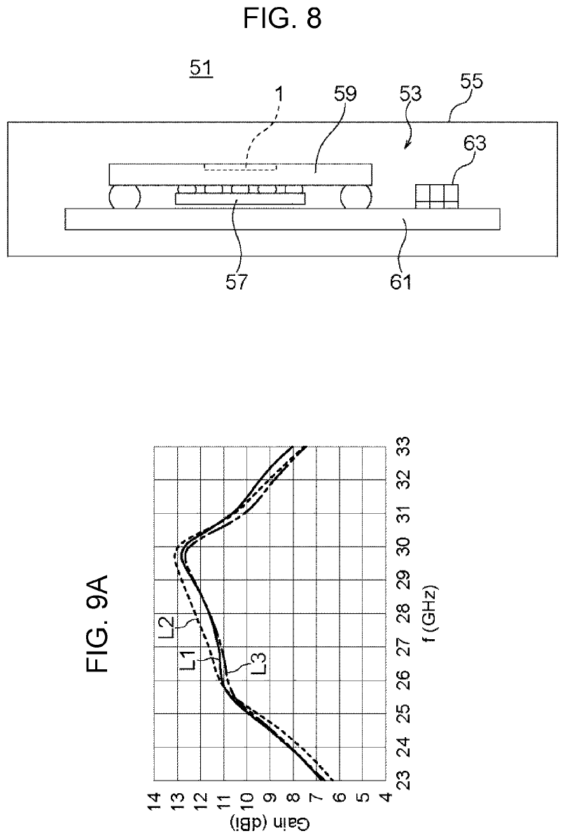

FIG. 8 is a schematic diagram illustrating the structure of an electronic apparatus 51 as an application for an antenna according to an embodiment. In the following description, the antenna is denoted by 1 as in the first embodiment for convenience. However, the electronic apparatus 51 may include the antenna according to the second embodiment.

The electronic apparatus 51 may be of various types. For example, the electronic apparatus 51 may be a communication device. Examples of the communication device include a mobile terminal, a base station, a relay station, a master station of a wireless local area network (LAN), a receiver of a satellite positioning system, an antenna device detachably attached to various electronic apparatuses, a radio, a television set, and an on-board unit of an electronic toll collection (ETC) system. Examples of the mobile terminal include a mobile phone (including a smartphone), a tablet personal computer (PC), and a notebook PC. Examples of the electronic apparatus 51 other than the communication device include a radar apparatus and a microwave. The following description may be based on an assumption that the electronic apparatus 51 is a communication device.

The electronic apparatus 51 includes, for example, an antenna module 53 and a housing 55 containing the antenna module 53.

The antenna module 53 includes, for example, the antenna 1 and at least one of a transmission circuit or a reception circuit. The transmission circuit transmits radio waves through the antenna 1. The reception circuit receives radio waves through the antenna 1. The transmission circuit and/or the reception circuit may include, for example, at least one integrated circuit (IC) 57. The IC 57 is, for example, a radio frequency (RF) IC, and is electrically connected to the bottom ends of the feed vias 11.

The transmission circuit may, for example, modulate and increase the frequency of a baseband signal including any information, and input a high frequency signal to the antenna 1. The reception circuit may, for example, demodulate and reduce the frequency of a high frequency signal from the antenna 1 to obtain a baseband signal including any information.

The IC 57 (transmission circuit and/or reception circuit) may be connected to the antenna 1 in any manner. In the illustrated example, the antenna 1 constitutes a portion of one main surface of an antenna substrate 59. The IC 57 is mounted on the other main surface of the antenna substrate 59. Each feed via 11 is electrically connected to the IC 57 through a conductor (conductor layer and/or via) disposed in the antenna substrate 59.

In the illustrated example, the antenna module 53 includes a mount board 61 and an electronic component 63 in addition to the antenna substrate 59 and the IC 57. The antenna substrate 59 is mounted on the mount board 61. The electronic component 63 is also mounted on the mount board 61. The IC 57 (transmission circuit and/or reception circuit) may be a component mounted on the mount board 61.

As is clear from the above-described various types of the electronic apparatus 51 (e.g., mobile terminal), the electronic apparatus 51 may be made of any material and have any size and shape. The relative size between the antenna 1 and the electronic apparatus 51 may also be any size.

The art according to the present disclosure is not limited to the above embodiments, and may be carried out in various ways.

For example, the antenna may include no first dielectric layer 7. For example, a region below the antenna layer 5 may be a space (from another perspective, air). When the antenna layer includes two or more conductor layers (for example, the feed patch 21 and the parasitic patch 19), the above applies also to a dielectric layer (second dielectric layer 15) disposed between the conductor layers. In this case, the conductor layers may be fixed to each other by, for example, a column composed of an insulator.

A concept that is not based on an assumption that the antenna is an array antenna may be derived from the present disclosure. For example, concept 1 described below may be derived.

### (Concept 1)

An antenna including:
a circular polarized antenna (antenna element, antenna layer); and
a ground pattern (ground layer) facing the circular polarized antenna,
wherein the ground pattern has a shape obtained by chamfering only one of two pairs of opposite corners of a square in plan view.

### REFERENCE SIGNS

1 . . . circular polarized array antenna, 3 . . . antenna element, 5 . . . antenna layer, 9 . . . ground layer, 27 . . . ground pattern.

1. A circular polarized array antenna comprising:
an antenna layer comprising a plurality of antenna elements disposed at different positions in plan view, each of the antenna elements being composed of a circular polarized antenna; and
a ground layer facing the antenna layer,
wherein the ground layer includes a plurality of ground patterns separated from each other, each of the ground patterns facing one or more of the antenna elements.

2. The circular polarized array antenna according to claim 1,
wherein the ground patterns face the antenna elements in one-to-one correspondence.

3. The circular polarized array antenna according to claim 2,
wherein each of the ground patterns covers one of the antenna elements in transparent plan view.

4. The circular polarized array antenna according to claim 2,
wherein each of the ground patterns has a square shape in plan view.

5. The circular polarized array antenna according to claim 2,
wherein each of the ground patterns has a shape obtained by chamfering only one of two pairs of opposite corners of a square in plan view.

6. The circular polarized array antenna according to claim 2,
wherein at least some of the antenna elements are arranged in a first direction, and
wherein each of the ground patterns has a maximum length in the first direction and a maximum length in a second direction orthogonal to the first direction, the maximum length in the first direction being equal to the maximum length in the second direction.

7. The circular polarized array antenna according to claim 1,
wherein a distance between adjacent ones of the ground patterns is equal to or greater than 1/10 of a maximum diameter of each of the antenna elements in plan view.

8. The circular polarized array antenna according to claim 1,
wherein a minimum diameter of each of the ground patterns is equal to or greater than a maximum diameter of each of the antenna elements in plan view.

9. An electronic apparatus comprising:
the circular polarized array antenna according to claim 1; and
an IC connected to the circular polarized array antenna.
